(19) United States
(12) Patent Application Publication
(10) Pub. No.: US 2011/0220727 A1
(43) Pub. Date: Sep. 15, 2011

(54) RFID Tag Antenna and RFID Tag

(75) Inventors: Byung Je Lee, Seoul (KR); Byung Gil Yu, Seoul (KR); Nak Chung Choi, Seoul (KR); Chang Hwan Oh, Seoul (KR); Eun Duck Lee, Gyeonggi-do (KR); Jong Hoon Park, Gyeonggi-do (KR); Sun Byuong Park, Chungcheongnam-do (KR); Kyung Hun Kim, Gyeonggi-do (KR)

(73) Assignee: Techno Semichen Co. Ltd., Gyeonggi-do (KR)

(21) Appl. No.: 13/129,653

(22) PCT Filed: Nov. 19, 2008
(86) PCT No.: PCT/KR2008/006823

§ 371 Date: May 17, 2011

(51) Int. Cl. G06K 19/077; H01Q 9/16

(52) U.S. Cl. 235/492; 343/822

(57) ABSTRACT

The present invention relates to a radio frequency identification (RFID) tag antenna and an RFID tag, in which a connection part where a radiator dipole and a T-junction are connected has a branch structure, so that an electric current can be induced in the T-junction and the radiator dipole by the branch structure, and the amount of the electric current induced in the radiator dipole can be adjusted to thereby control impedance of the RFID tag antenna in detail. The RFID tag antenna includes: a substrate; a radiator dipole symmetrically printed on the substrate in a form of meanders; and a T-junction formed between the symmetrical radiator dipoles, formed integrally with each end part of the symmetrical radiator dipoles and performing impedance matching between the radiator dipole and an RFID tag chip, wherein a connection part where the symmetrical radiator dipole and the T-junction are connected has a branch structure.

### TECHNICAL FIELD

The present invention relates to a radio frequency identification (RFID) tag antenna and an RFID tag, and more particularly to an RFID tag antenna and an RFID tag, in which a connection part where a radiator dipole and a T-junction are connected has a branch structure, so that an electric current can be induced in the T-junction and the radiator dipole by the branch structure, and the amount of the electric current induced in the radiator dipole can be adjusted to thereby control impedance of the RFID tag antenna in detail.

### BACKGROUND ART

Radio frequency identification (RFID) is configured with an RFID tag, various antennas, a reader according to performances, a local host of supporting the reader, diverse cabling and network connection, in which a tag to be attached to goods contains information about a full history of production, distribution, preservation and consumption, and a chip with a built-in antenna allows the reader to read this information and is used as being integrated with an information system in connection with a satellite or a mobile network.

With regard to industrial applicability, an RFID system, which is a new technology capable of wirelessly storing information through the RFID tag with a micro chip and a micro antenna, has advantages of being irrespective of a reading position as opposed to a barcode system and automatically reading the tag at a farther distance than that of a barcode.

In particular, the RFID system is being in the spotlight as a technology to bring an innovation in distribution and physical distribution since it attaches an electronic tag to various goods and automatically reads goods' specifications, costs, distribution channels, expiry date, etc. without using a scanner to read the electronic tags one by one.

In RFID tag technology, the antenna supplies electric power to the tag and the tag returns data in response to the electric power, in which there have been generally employed a method using a magnetic field and a method using an electric wave. In other words, the RFID tag technology is classified into an inductive coupling type and a backscatter coupling type.

The inductive coupling type is based on a principle that a magnetic field generated by high frequency waves from the antenna induces an electric current while passing through an antenna coil of the tag, and employed in a frequency band (e.g., 125 KHz, 134 KHz, 13.56 MHz) equal to or lower than 30 MHz. Further, the inductive coupling type has a feature that the magnetic field is absorbed in metal.

On the other hand, the backscatter coupling type is based on a principle that the antenna sends the electric wave to the tag and the tag uses the received electric wave as power like a radar, and employed in a frequency band (e.g., 900 MHz, 2.45 GHz) equal to or higher than 100 MHz. Further, the backscatter coupling type has a feature that the electric wave is reflected from metal but absorbed in water.

In the case of the backscatter coupling type as opposed to the inductive coupling type that uses the antenna coil at a close distance, the antenna of the tag receives a signal transmitted as air waves in air condition from the antenna of the reader, and an radio frequency (RF) component of the received signal is employed for generating power to be used by the RFID tag chip. In the case of the backscatter coupling type, a function of a demodulator, which filters off high frequency and applies 1 bit analog-to-digital (AD) conversion to a baseband signal of low frequency, is performed.

However, while the inductive coupling type has no problem of generating power because much power is induced, the backscatter coupling type has a problem in that a signal having an enough level of 3.5V is input at a close distance where the reader and the tag almost come in contact with each other but a signal having a very low level of 125 mV is input at a distance of 5 meters.

Accordingly, a voltage multiplier is employed to generate desired power from the very low level signal. To multiply the voltage of the very low level signal, a Schottky diode that needs a low voltage to be turned on and has good efficiency and a special metal oxide semiconductor (MOS) transistor are used in making a circuit, so that the circuit can become complicated and the costs thereof can increase.

Theoretically, the RFID tag chip integrated circuit (IC) receives maximum power at highest efficiency if the antenna and the RFID tag chip have the same impedance. However, the RFID tag chip has a scattered input impedance because of its own RLC scatter and parasitic resistance and capacitance components formed when the RFID tag chip IC and the antenna are assembled, and thus the impedance of the antenna and the input impedance of the RFID tag chip IC are not accurately the same and differ by the scatter. With these components at a ultra high frequency (UHF) tag of 900 MHz, a frequency characteristic is largely varied by even several ohms and also the level of the input signal becomes lower, so that a receivable distance of the tag can become shorter and thus a yield can be lowered.

Accordingly, a conventional UHF band RFID tag antenna has a structure for impedance conjugate matching with the RFID tag chip. For example, as shown in FIG. 1, the conventional UHF band RFID tag antenna has a T-junction employing various T-junction loop structures for the impedance matching.

The T-junction is a structure for achieving the conjugate matching through high-Q impedance while keeping a voltage difference between a ground and an RF terminal of the RFID tag chip. Most of the T-junction loop structures are embodied with a loop line between the ground and the RF terminal of the RFID tag chip.

However, the T-junction needs to change the size of the loop line or a connection point of a radiator in order to adjust the impedance. Also, it is difficult for the T-junction to achieve accurate impedance matching with the RFID tag chip since real and imaginary parts of the impedance are largely varied depending on frequencies.

The reason why it is difficult to achieve the accurate impedance matching is, as shown in FIGS. 2(a) and 3(a), because the loop line of the T-junction 10 and the radiator dipole 20 are directly connected and thus the impedance and a resonance frequency are largely varied depending on a connection part 21 and a radius of the loop line of the T-junction 10. Accordingly, there is a need of solving the foregoing shortcomings to maximize the performance of the RFID tag.

Referring to FIG. 2(a), the position of the connection part 21 where the T-junction 10 and the radiator dipole 20 are connected is changeable in the existing RFID tag antenna, and at this time the impedance and the resonance frequency are varied as shown in FIG. 2(b). Referring to FIG. 2(b), the variance in the impedance and the resonance frequency is very large when the position of the connection part 21 is changed from 1 mm to 3 mm. This shows that the change in the position of the connection part 21 is not proper to adjust the impedance.

Referring to FIG. 3(a), the loop size of the T-junction 10 is changeable in the existing RFID tag antenna, and at this time the impedance and the resonance frequency are varied as shown in FIG. 3(b). Referring to FIG. 3(b), the variance in the impedance and the resonance frequency is very large when the loop size of the T-junction 10 is changed from 1 mm to 3 mm. This shows that the change in the loop size of the T-junction 10 is not proper to adjust the impedance.

As described above, when the loop size of the T-junction 10 or the position of the connection part 21 is changed, the impedance and the resonance frequency are varied largely. In result, it is not easy to achieve the impedance conjugate matching between the RFID tag antenna and the RFID tag chip.

### Disclosure

### Technical Problem

The present invention is conceived to solve the problems of the conventional techniques as described above, and an aspect of the present invention is to provide a radio frequency identification (RFID) tag antenna and an RFID tag, in which a connection part where a radiator dipole and a T-junction are connected has a branch structure, so that an electric current can be induced in the T-junction and the radiator dipole by the branch structure, and the amount of the electric current induced in the radiator dipole can be adjusted to thereby control impedance of the RFID tag antenna in detail.

### Technical Solution

The foregoing and/or other aspects of the present invention are achieved by providing a radio frequency identification (RFID) tag antenna including: a substrate; a radiator dipole symmetrically printed on the substrate in a form of meanders; and a T-junction formed between the symmetrical radiator dipoles, formed integrally with each end part of the symmetrical radiator dipoles and performing impedance matching between the radiator dipole and an RFID tag chip, wherein a connection part where the symmetrical radiator dipole and the T-junction are connected has a branch structure.

The connection part may include a plurality of branch structures connected in series or in parallel. For example, the connection part may be formed by connecting the plurality of branch structures in series.

The branch structure may include one among a circular structure, a semicircular structure and a polygonal structure. That is, the connection part may have various shapes as long as it is the branch structure.

A terminal of the radiator dipole may be formed to have a larger area than other parts of the radiator dipole, and the terminal of the radiator dipole may have a “ [symbol] ”-shape.

Another aspect of the present invention is to provide a radio frequency identification (RFID) tag including: a substrate; a radiator dipole symmetrically printed on the substrate in a form of meanders; a T-junction formed between the symmetrical radiator dipoles, formed integrally with each end part of the symmetrical radiator dipoles and performing impedance matching between the radiator dipole and an RFID tag chip; and an RFID tag chip applying a data process to signals transmitted from and received by the radiator dipole, wherein a connection part where the symmetrical radiator dipole and the T-junction are connected has a branch structure.

### Advantageous Effects

According to a radio frequency identification (RFID) tag antenna and an RFID tag with the above problems and configurations, a connection part where a radiator dipole and a T-junction are connected has a branch structure, so that an electric current can be induced in the T-junction and the radiator dipole by the branch structure, and the amount of the electric current induced in the radiator dipole can be adjusted to thereby control impedance of the RFID tag antenna in detail. Thus, it is easy to achieve impedance matching between the RFID antenna and the RFID chip.

### DESCRIPTION OF DRAWINGS

FIG. 1 is an actual photograph of a conventional radio frequency identification (RFID) tag antenna.

FIGS. 2(a) and 2(b) are an illustrative view and a graph which show change in a position of a connection part and corresponding variation in impedance and a resonance frequency, respectively.

FIGS. 3(a) and 3(b) are an illustrative view and a graph which show change in a loop size of a T-junction and corresponding variation in impedance and a resonance frequency, respectively.

FIGS. 4(a) to 4(c) are plan views of various RFID tag antennas according to an exemplary embodiment of the present invention.

FIG. 5 is a view showing a shape of a radiator dipole terminal according to an exemplary embodiment of the present invention and its current distribution.

FIGS. 6(a) to 6(c) are photographs showing current density and surface current flow formed in the RFID tag antenna according to an exemplary embodiment of the present invention.

FIGS. 7(a) to 7(c) are an illustrative view showing change in an inside radius and an outside radius of a connection part, and graphs showing corresponding variations in impedance and a resonance frequency.

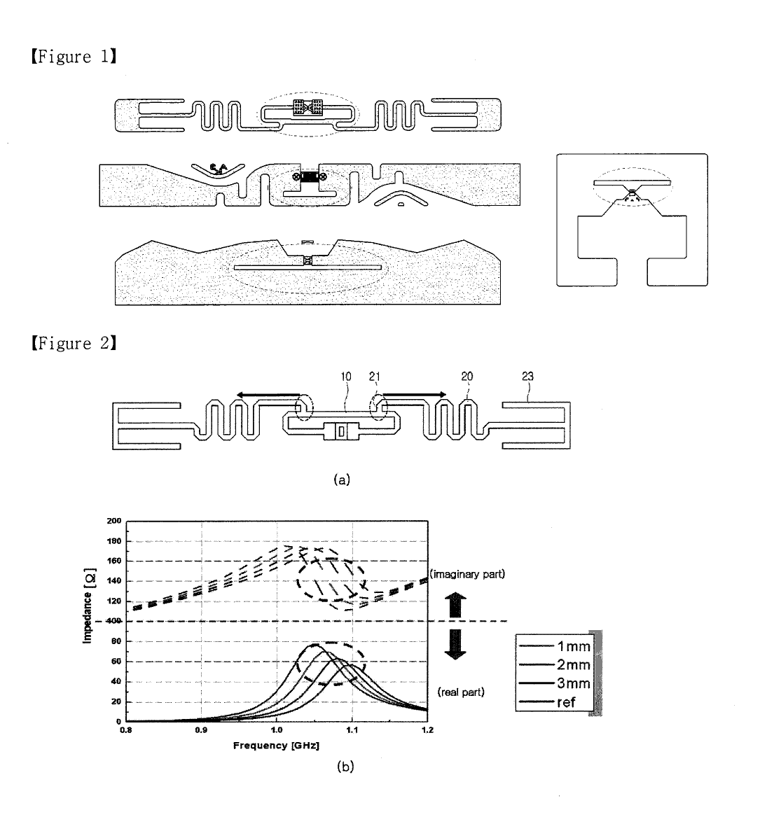

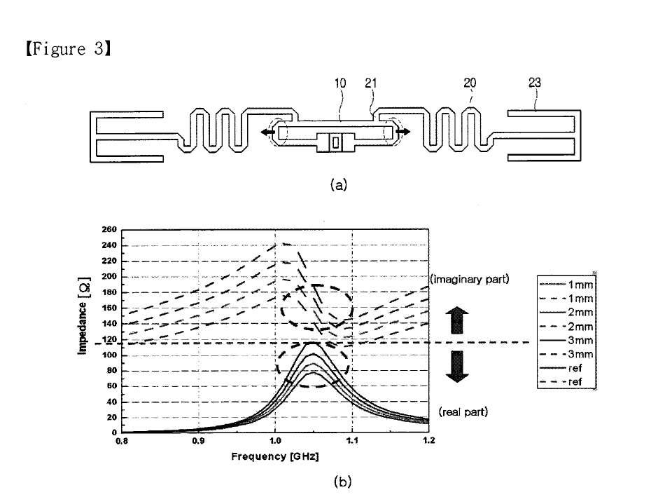

*Reference Numerals for the Drawings*

| | |
|---|---|
| 10: T-junction | 20: radiator dipole |
| 21: connection part | 23: terminal of radiator dipole |

### BEST MODE

Hereinafter, exemplary embodiments of a radio frequency identification (RFID) tag antenna and an RFID tag according to the present invention with the above problems and configurations will be described in detail with reference to accompanying drawings.

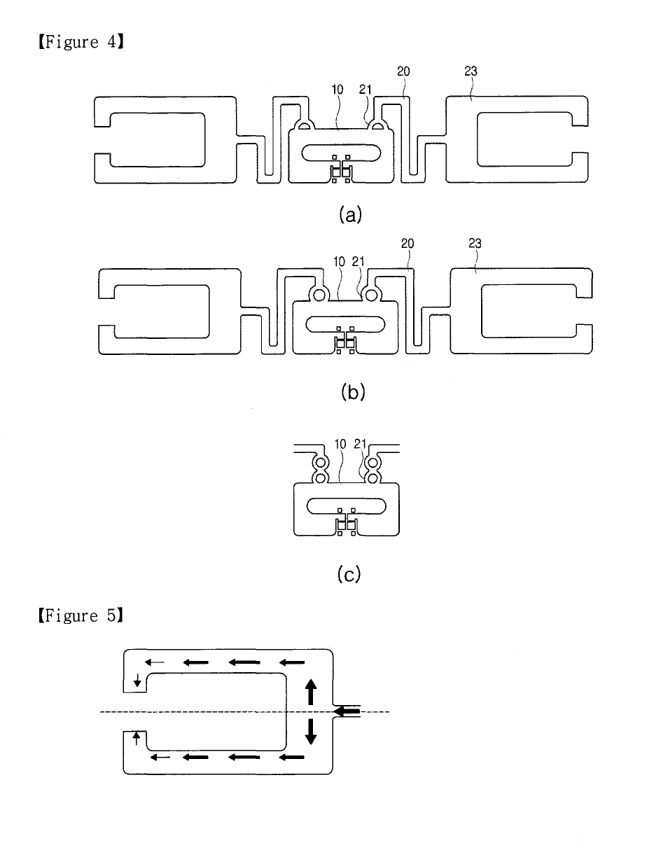

FIGS. 4(a) to 4(c) are plan views of various RFID tag antennas according to an exemplary embodiment of the present invention.

Referring to FIGS. 4(a) to 4(c), an RFID tag antenna according to an exemplary embodiment of the present invention includes a substrate (not shown), a radiator dipole 20 symmetrically printed on the substrate in the form of meanders, and a T-junction 10 formed between the symmetrical radiator dipoles 20.

The substrate (not shown) is a plate where the radiator dipole 20 and the T-junction 10 are formed, which can be formed of various non-conductive materials. For example, wood, Teflon, plastics, or the like printing materials may be used as the substrate.

The radiator dipole 20 printed on the substrate is symmetrically formed at opposite sides of the T-junction 10 as shown in FIGS. 4(a) to 4(c). Further, the radiator dipole 20 is shaped like meanders that wander.

The radiator dipole 20 serves as a medium for a radio frequency (RF) signal power between an RFID reader and an RFID tag chip, and is printed with a conductive ink of a metal coating such as gold, silver, copper, bronze, etc. on the substrate. Further, the size of the radiator dipole 20 is designed to generate resonance at a use frequency and easily radiate an electromagnetic field in all directions.

The T-junction 10 formed between the symmetrical radiator dipoles 20 is formed integrally with each end part of the radiator dipoles 20 as shown in FIGS. 4(a) to 4(c). The T-junction 10 performs impedance matching between the RFID tag antenna including the radiator dipole 20 and the RFID tag chip.

According to an exemplary embodiment of the present invention, a structural change is carried out to easily achieve the impedance matching between the RFID tag antenna including the radiator dipole 20 and the RFID tag chip. That is, a connection part 21 where the symmetrical radiator dipole 20 and the T-junction 10 are connected is changed to have a branch structure.

As opposed to the conventional single line, the connection part 21 has the branch structure of being divided into two lines. The connection part 21 with the branch structure serves to induce an electric current in the T-junction 10 and the radiator dipole 20, and is capable of controlling the impedance of the RFID tag antenna in detail by adjusting the amount of the electric current induced in the radiator dipole 20.

The connection part 21 may have one branch structure as shown in FIGS. 4(a) and 4(b), and may have a plurality of branch structures connected in series as shown in FIG. 4(C) or connected in parallel. That is, the connection part 21 may be formed by connecting the plurality of branch structures in series or parallel.

Also, the branch structure of the connection part 21 may have various shapes. For example, the branch structure may have a semicircular shape as shown in FIG. 4(a), and may have ea circular shape as shown in FIG. 4(b). Alternatively, the branch structure may have a polygonal shape such as a triangle, a rectangle, etc.

Meanwhile, a terminal 23 of the radiator dipole 20 may be formed to have a larger area than other parts of the radiator dipole 20 (refer to FIGS. 4(a) and 4(b)). Further, the terminal 23 of the radiator dipole 20 may have a “ [symbol] ”-shape.

The terminal 23 of the radiator dipole 20 is a place where an electric field alternates between the maximum and the minimum as time goes by. In the electric dipole antenna, the terminal 23 is also a place where radiation resistance is the highest.

If the area of the terminal 23 of the radiator dipole 20 becomes larger, the antenna is improved in radiation efficiency, but the tag has to be realized within a limited size while maximizing performance. Accordingly, the radiation structure has the “ [symbol] ”-shape so that it can maximize the performance with respect to the size. As shown in FIG. 5, the electric current has uniform distribution between magnetic walls.

According to an exemplary embodiment of the present invention, the terminal 23 of the radiator dipole 20 forms the magnetic wall as one of boundary conditions in the middle of the “ [symbol] ”-shape when considering the phase and the intensity of the electric current. Further, the structures that have the same current and phase are regarded as opened because they are adjacent to each other.

If the respective structures has the uniform current distribution and the same phase while forming the magnetic wall, an electric effective aperture area of the antenna seems to be large, thereby increasing the efficiency of the antenna.

### Mode for Invention

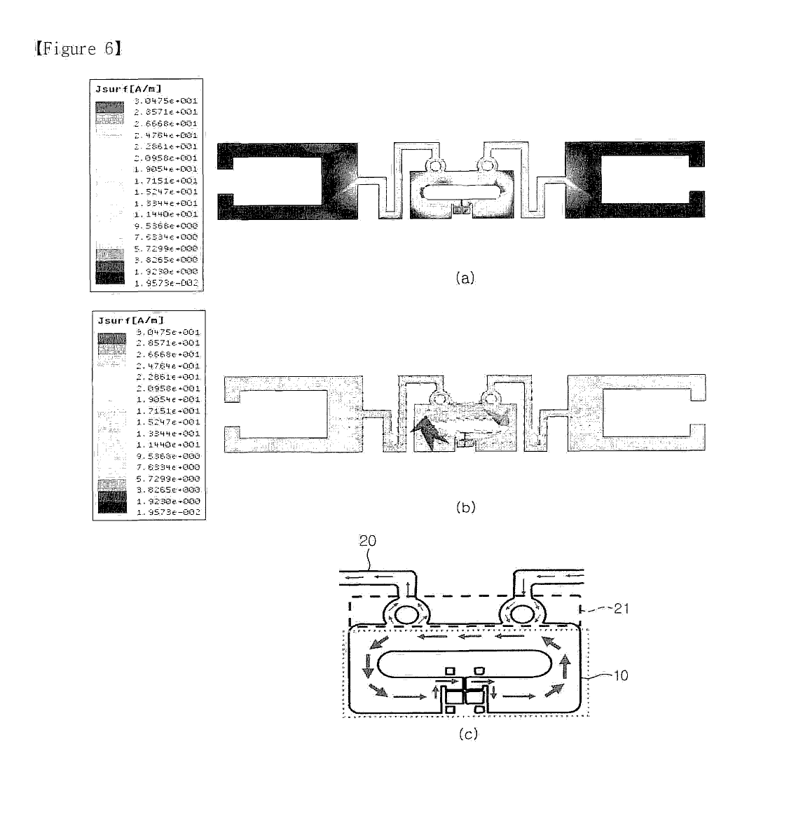

FIG. 6(a) shows distribution of current density in the case that the connection part 21 has the branch structure according to an exemplary embodiment of the present invention, FIG. 6(b) shows distribution of surface current, and FIG. 6(c) shows a current direction in a circled part of FIG. 6. In other words, the current induced in the radiator dipole is ascertained on the basis of the current density and the current direction in the branch structure according to an exemplary embodiment of the present invention, and the current is induced so that the radiator can operate as the dipole.

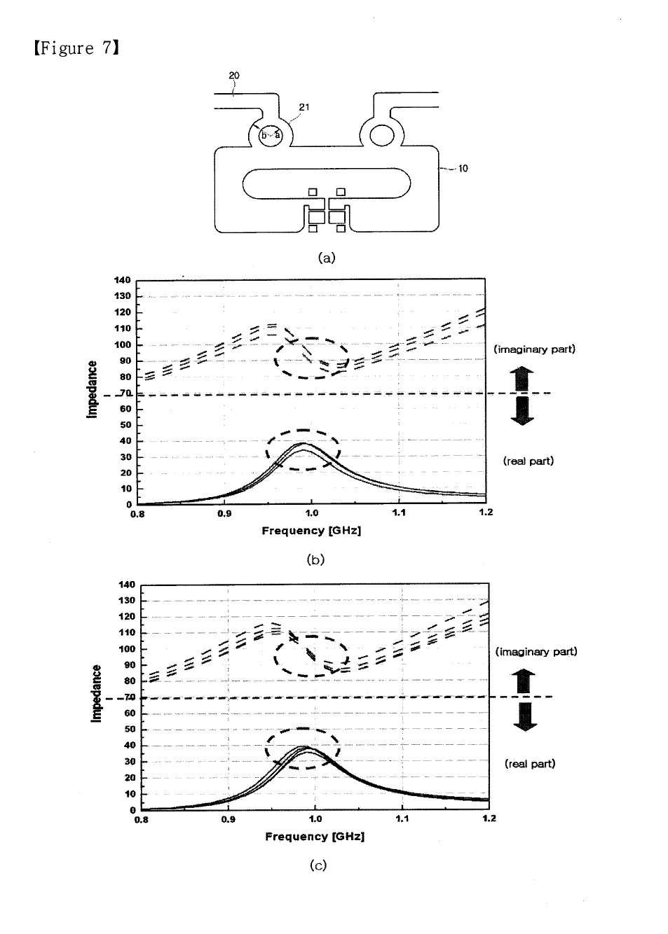

FIG. 7(a) shows that an inside radius a and an outside radius b of the connection part 21 are changeable, FIG. 7(b) is a graph showing variations of the impedance and the frequency when the inside radius a of the connection part 21 is changed, and FIG. 7(c) is a graph showing variations of the impedance and the frequency when the outside radius a of the connection part 21 is changed.

Referring to FIGS. 7(a) to 7(c), the current density between the T-junction and the radiator dipole is adjustable by changing the inside radius or the outside radius of the connection part having the branch structure, and the amount of the current is adjustable by changing the radius of the branch structural line with the inside radius or the outside radius. Thus, the amount of the current induced from the T-junction to the radiator dipole is adjusted in more detail, so that the input impedance of the antenna can be efficiently and easily controlled.

As shown in FIGS. 7(b) and 7(c), the impedance and the frequency are not largely varied even though the inside radius and the outside radius of the connection part 21 according to an exemplary embodiment of the present invention are changed. Thus, it will be appreciated that the accurate impedance matching can be adjusted by changing the inside radius and the outside radius of the connection part 21 according to an exemplary embodiment of the present invention, thereby making the impedance matching easy.

### INDUSTRIAL APPLICABILITY

The RFID tag antenna with the foregoing structure and characteristics according to an embodiment of the present invention is used in the RFID tag. For instance, the antenna with the above structure is connected to the RFID tag chip, thereby completing the RFID tag. The RFID tag chip applies a data process to signals transmitted from and received by the radiator dipole. For example, the RFID tag chip senses RF signal power from the antenna and performs the data process, which includes a modulation circuit, a detection circuit, a rectification circuit, a microprocessor, and so on.

1. A radio frequency identification (RFID) tag antenna comprising:
a substrate;
a radiator dipole symmetrically printed on the substrate in a form of meanders; and
a T-junction formed between the symmetrical radiator dipoles, formed integrally with each end part of the symmetrical radiator dipoles and performing impedance matching between the radiator dipole and an RFID tag chip,
wherein a connection part where the symmetrical radiator dipole and the T-junction are connected has a branch structure.

2. The RFID tag antenna according to claim 1, wherein the connection part comprises a plurality of branch structures connected in series or in parallel.

3. The RFID tag antenna according to claim 1, wherein the branch structure comprises one among a circular structure, a semicircular structure and a polygonal structure.

4. The RFID tag antenna according to claim 1, wherein the radiator dipole comprises a terminal having a “ [symbol] ”-shape.

5. A radio frequency identification (RFID) tag comprising:
a substrate;
a radiator dipole symmetrically printed on the substrate in a form of meanders;
a T-junction formed between the symmetrical radiator dipoles, formed integrally with each end part of the symmetrical radiator dipoles and performing impedance matching between the radiator dipole and an RFID tag chip; and
an RFID tag chip applying a data process to signals transmitted from and received by the radiator dipole,
wherein a connection part where the symmetrical radiator dipole and the T-junction are connected has a branch structure.

6. The RFID tag antenna according to claim 2, wherein the branch structure comprises one among a circular structure, a semicircular structure and a polygonal structure.
